(19) United States
(12) Patent Application Publication
(10) Pub. No.: US 2006/0160583 A1
(43) Pub. Date: Jul. 20, 2006

(54) Folding-type portable apparatus

(75) Inventor: Yun-Sun Ryu, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/264,722

(22) Filed: Nov. 1, 2005

(30) Foreign Application Priority Data
Jan. 19, 2005 (KR) 10-2005-0005050

(51) Int. Cl. H04M 1/00

(52) U.S. Cl. 455/575.3

(57) ABSTRACT

A folding-type portable apparatus includes a body having a center hinge arm, which contains a hinge module, protruding from the upper surface thereof; a folder having a pair of hinge knuckle portions and rotatably coupled to the body by means of the hinge module; and a constraint means positioned on the folder to interrupt any force transmitted to the pair of hinge knuckle portions during folding and unfolding operations and prevent them from being displaced away from each other.

This application claims priority to an application entitled “Folding-type Portable Apparatus” filed with the Korean Intellectual Property Office on Jan. 19, 2005 and assigned Serial No. 2005-5050, the contents of which are incorporated herein by reference.

### BACKGROUND OF THE INVENTION

1. Field of the Invention

The present invention relates to digital portable communication apparatuses including cellular phones, personal digital assistants (PDAs), hand held phones (HHPs), camera phones, and game phones, and more particularly to a folding-type portable apparatus having improved product reliability by providing structural rigidity.

2. Description of the Related Art

In general, a “portable communication apparatus” refers to an electronic apparatus that a user can carry to perform wireless communication with a desired partner. To facilitate portability, designs of such portable communication apparatuses tend not only to be compact, slim, and light, but are also moving toward providing multimedia availability, having a wider variety of functions. Future portable communication apparatuses are expected to incorporate greater multi-functionality and be capable of multi-purpose utilization, as well as, to be more compact, light, and capable of being modified to be suitable for various multimedia or Internet environments. These portable communication apparatuses are now commonly used by people of all ages and all walks of life throughout the world, and are recognized by some people as a nearly indispensable device which must be carried at all times.

Portable communication apparatuses may be classified into various categories according to their appearance, such as bar-type portable communication apparatuses, flip-type portable communication apparatuses, and folder-type portable communication apparatuses. Portable communication apparatuses may also be classified into neck-wearable type portable communication apparatuses and wrist-wearable type portable communication apparatuses according to the position or way in which users put on the devices. In addition, portable communication apparatuses may be classified into rotation-type portable communication apparatuses and sliding-type communication apparatuses according to the manner of opening and closing the devices. These variously classified portable communication apparatuses can be easily understood by those skilled in the art.

Conventional portable communication apparatuses now often have the ability to transmit data at a high speed, in addition to performing the basic voice communication function. As a result of consumer demand, portable communication apparatuses now tend to provide a service using a wireless communication technology capable of transmitting data at ever-increasing high speeds.

Recent portable communication apparatuses also are likely to be equipped with a camera lens to obtain video signals for transmission. These devices may have an external or embedded camera lens module which enables users to perform video communication with desired partners or to photograph desired subjects.

A conventional folding-type communication apparatus is described below with reference to FIG. 1. A conventional folding-type portable apparatus includes a body 410, a folder 420, and a hinge device 433 for rotatably connecting the body 410 and the folder 420. The folder 420 is folded on and unfolded from the body 410 about a hinge axis A provided by a hinge module (not shown). The hinge device 433 includes a pair of side hinge arms 432 positioned on the body 410, a center hinge arm 434 positioned on the folder 420 between the side hinge arms 432, and a hinge module (not shown) positioned inside the center hinge arm 434 to couple the side hinge arms 432 and the center hinge arm 434. The hinge device 433 provides a force in such a manner that the folder 420 is folded on the body 410 when the folder 420 and the body 410 are separated by less than a predetermined angle. The hinge device 433 provides a force in such a manner that the folder 420 is unfolded from the body 410 when the folder 420 and the body 410 are separated by the predetermined angle or greater. The construction of the hinge device can be easily understood by those skilled in the art.

However, conventional folding-type portable apparatuses have a problem in that, when the folder is improperly folded and unfolded, the center hinge arm 434 of the folder and the side hinge arms 432 of the body may crack. Such cracking occurs when the user applies an excessive force to the folder 420 to fold and unfold it. The excessive force is transmitted to the side hinge arms 432 or the center hinge arm 434. The neck of the side hinge arms 432 and both ends and the neck of the center hinge arm 434 frequently crack. A metallic material may be used to strengthen the parts vulnerable to cracking. However, the use of metallic materials adds weight which is not consistent with the current trend toward lightness of portable apparatuses.

### SUMMARY OF THE INVENTION

Accordingly, the present invention has been made to solve the above-mentioned problems occurring in the prior art. An object of the present invention is to provide a folding-type portable apparatus having improved product reliability by providing excellent structural rigidity when the folder is folded and unfolded.

Another object of the present invention is to provide a folding-type portable apparatus having reinforced structural rigidity of the folder's neck by preventing the hinge knuckle portions from widening.

In order to accomplish this object, there is provided a folding-type portable apparatus including a body having a center hinge arm, which contains a hinge module, protruding from the upper surface thereof; a folder having a pair of hinge knuckle portions and rotatably coupled to the body by means of the hinge module; and a constraint means, positioned on the folder, to interrupt any force transmitted to the pair of hinge knuckle portions during the folding and unfolding operations and to prevent them from being displaced away from each other.

### BRIEF DESCRIPTION OF THE DRAWINGS

The above and other objects, features, and advantages of the present invention will be more apparent from the following detailed description taken in conjunction with the accompanying drawings, in which:

FIG. 1 is a perspective view showing a conventional folding-type portable apparatus;

FIG. 2 is a perspective view showing a folding-type portable apparatus according to the present invention;

FIG. 3 is a perspective view showing the body of a folding-type portable apparatus according to the present invention;

FIG. 4 is a perspective view showing the folder of a folding-type portable apparatus according to the present invention;

FIG. 5 is a lateral view of the folder shown in FIG. 4;

FIG. 6 is a partially-broken front view of a constraint means of the folder shown in FIG. 4;

FIG. 7 is a perspective view showing a hinge knuckle portion of a folding-type portable apparatus according to the present invention; and

FIG. 8 is a perspective view showing a hinge dummy of a folding-type portable apparatus according to the present invention.

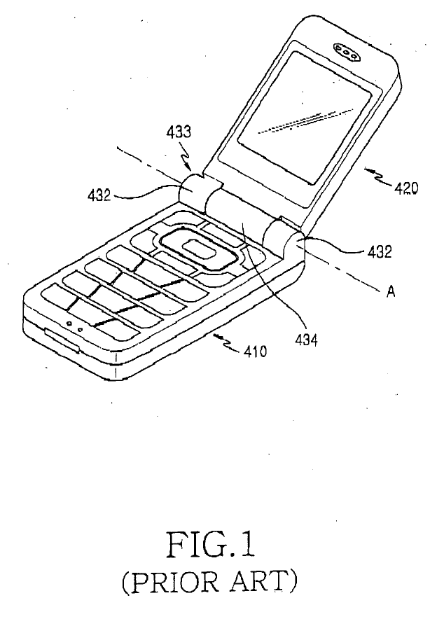

### DETAILED DESCRIPTION OF THE PREFERRED EMBODIMENT

Hereinafter, a preferred embodiment of the present invention will be described with reference to the accompanying drawings. In the following description of the present invention, a detailed description of known functions and configurations incorporated herein is omitted to avoid making the subject matter of the present invention unclear.

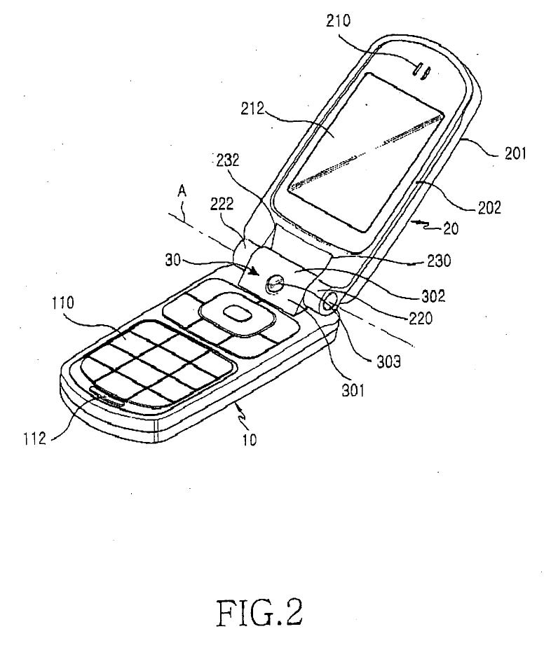

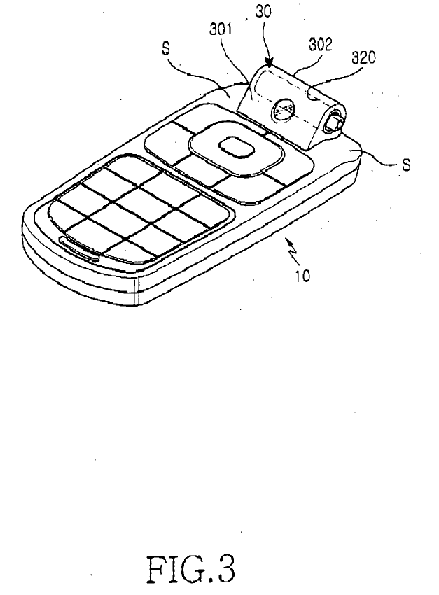

As shown in FIGS. 2 and 3, a folding-type portable apparatus according to the present invention includes a body 10, a folder 20, a hinge device for rotatably connecting the body 10 and the folder 20, and a constraint means for preventing a pair of hinge knuckle portions 220 and 222 positioned on an end of the folder 20 from widening. The constraint means will be described later in more detail.

The body 10 includes a number of keys 110 positioned on the upper surface thereof, a microphone device 112 positioned adjacent to a side of the keys 110, and a center hinge arm 30 positioned adjacent to the other side of the keys 110. The center hinge arm 30 includes a slant body 301 extending from the upper surface with a slant and a cylindrical body 302 containing a hinge module 320. A pair of slots S are formed on both sides of the center hinge arm 30 to accommodate the hinge knuckle portions 220 and 222. The slant body 301 has a key 303. As the slant body 302, is slanted from the vertical direction, the user can perform key pressing operations conveniently.

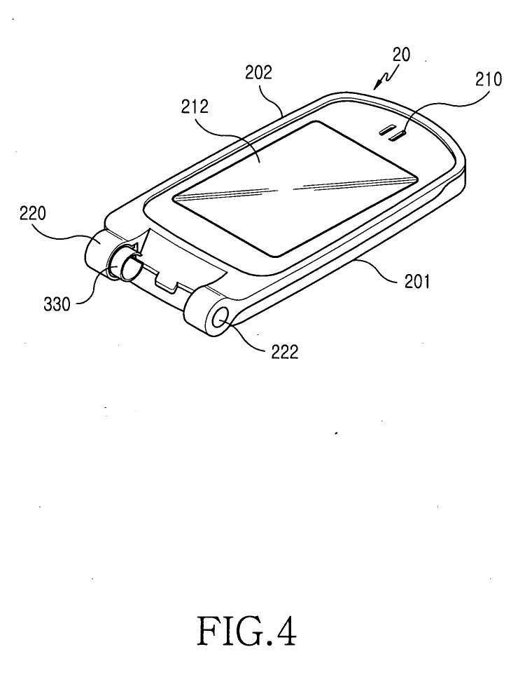

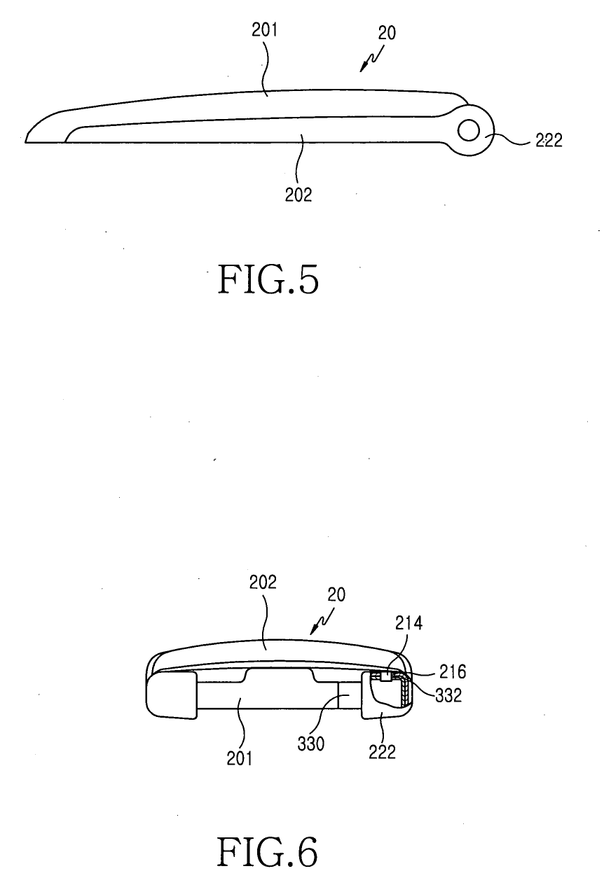

As shown in FIGS. 4 and 5, the folder 20 includes an upper case 201 and a lower case 202 coupled to the upper case 201. The lower case 202 has a pair of hinge knuckle portions 220 and 222 protruding from an end thereof. One knuckle portion 222 is coupled to the hinge module 320 (shown in FIG. 3) and the other knuckle portion 220 is coupled to a hinge dummy 330. The hinge module 320 provides a semi-automatic force to fold and unfold the folder 20. A flexible circuit (not shown) extends via the hinge dummy 330. The hinge knuckle portions 220 and 222 need not necessarily be positioned on the lower case 202, but instead they may be positioned on the upper case 201.

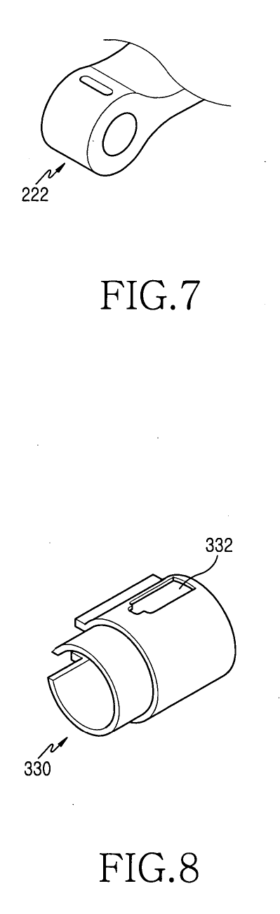

As shown in FIGS. 6 to 8, the folder 20 has a constraint means for preventing the hinge knuckle portions 220 and 222 from widening, which are coupled to the hinge module 320, when the folder 20 is folded and unfolded. The constraint means prevents any force from being transmitted to the hinge knuckle portions 220 and 222, when the folder is folded and unfolded, lest they should be displaced away from each other. Specifically, the constraint means includes a protrusion 214 positioned on the upper case 201 and a first opening 216 formed on a hinge knuckle portion 220 chosen from the pair of hinge knuckle portions 220 and 222, to which the protrusion 214 is coupled. The protrusion 214 extends downward from the upper case 201 along a hinge axis. The first opening 216 extends along a longitudinal direction, particularly along the hinge axis, from the outer peripheral surface of the hinge knuckle portion 220. The hinge knuckle portion 220 is provided with a hinge dummy 330 having a second opening 332 to which the protrusion 214 is coupled. The second opening 332 extends linearly along the longitudinal direction, particularly along the hinge axis, from the outer peripheral surface of the hinge dummy 330 inserted into the hinge knuckle portion 220. The hinge dummy 330 is made of a metallic material. The protrusion 214 need not necessarily be positioned on the upper case 201, but may be positioned on the lower case 202.

When the hinge dummy 330 is inserted into the hinge knuckle portion 220, the first and second openings 216 and 332 communicate with and face each other. The first and second openings 216 and 332 are coaxially positioned and the protrusion 214 has a length large enough to extend through the first and second openings 216 and 332. When the protrusion 214 is coupled to the first and second openings 216 and 332, the displacement of the pair of hinge knuckle portions 220 and 222 away from each other while the folder 10 is folded on or unfolded from the body 20 is minimized, as is the force transmitted to the necks 230 and 232 of the folder 20.

In summary, the protrusion 214 coupled to the first and second openings 216 and 332 provides a force in such a direction that the pair of hinge knuckle portions 220 and 222 are prevented from widening, i.e., from being displaced away from each other, and minimizes the force transmitted to the necks 230 and 232. This prevents the hinge knuckle portions 220 and 222, the necks 230 and 232, and the center hinge arm 30 from cracking.

As mentioned above, the folding-type portable apparatus according to the present invention has a hinge module positioned on the body and hinge knuckle portions positioned on the folder in such a manner that the hinge knuckle portions are prevented from widening. This provides structural rigidity and improves product reliability. In addition, the present invention provides more flexibility in designing the hinge portion of a portable apparatus.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A folding-type portable apparatus comprising:
a body having a center hinge arm containing a hinge module, protruding from an upper surface thereof;
a folder having a pair of hinge knuckle portions and rotatably coupled to the body by means of the hinge module; and
a constraint means positioned on the folder to interrupt any force transmitted to the pair of hinge knuckle portions during folding and unfolding operations and prevent the hinge knuckle portions from being displaced away from each other.

2. The folding-type portable apparatus as claimed in claim 1, wherein the folder comprises an upper case and a lower case assembled to the upper case, and the pair of hinge knuckle portions is positioned on the lower case.

3. The folding-type portable apparatus as claimed in claim 1, wherein the center hinge arm has a slant body.

4. The folding-type portable apparatus as claimed in claim 2, wherein the constraint means includes a protrusion protruding downward from the upper case while extending along a hinge axis and a first opening formed on any one of the pair of hinge knuckle portions, to which the protrusion is coupled.

5. The folding-type portable apparatus as claimed in claim 4, wherein the protrusion extends downward from the upper case and the first opening extends along the hinge axis from an outer peripheral surface of the hinge knuckle portion.

6. The folding-type portable apparatus as claimed in claim 4, wherein the hinge knuckle portion having the first opening has a hinge dummy.

7. The folding-type portable apparatus as claimed in claim 6, wherein the hinge dummy has a second opening to which the protrusion is coupled and the first and second openings face and communicate with each other.

8. The folding-type portable apparatus as claimed in claim 7, wherein the second opening extends along the hinge axis from an outer peripheral surface of the hinge dummy inserted into the hinge knuckle portion having the first opening.

9. The folding-type portable apparatus as claimed in claim 6, wherein the hinge dummy is made of a metallic material.

10. The folding-type portable apparatus as claimed in claim 3, wherein the slant body has a key for convenient key pressing operations.
